(19) United States
(12) Patent Application Publication
(10) Pub. No.: US 2010/0005000 A1
(43) Pub. Date: Jan. 7, 2010

(54) Advertising sales tool

(75) Inventors: Michael E. McKinzie, St. Louis, MO (US); Karen Barnett, Florissant, MO (US)

Correspondence Address: AT&T Legal Department - WW, Patent Docketing Room 2A-207, One AT&T Way, Bedminster, NJ, 07921, US

(73) Assignee: AT & T Mobility II LLC, Atlanta, GA (US)

(21) Appl. No.: 12/167,572

(22) Filed: Jul. 3, 2008

(51) Int. Cl. G06Q 30/00

(52) U.S. Cl. 705/14.73

(57) ABSTRACT

Online and paper-based telephone directory advertisement effectiveness may be determined and presented. A user interface may receive input, such as an advertisement characteristic. The advertisement characteristic may be part of an advertising mix including paper-based telephone directory advertisements and/or an online telephone directory advertisements. A processor may determine one or more effectiveness metrics, such as monthly call counts. The effectiveness metrics may be based on metered telephone directory listing information, generated by placing a number of unique metered telephone numbers in advertisements, recording data associated with calls made to these unique metered telephone numbers, and statistically processing the recorded data to generate models of how various advertisement types and characteristics have performed. The user interface may interactively present the metric and a sample advertisement that is in accordance with the inputted characteristic. The metric may include a return on investment calculation, providing an evidence-based, value proposition.

### BACKGROUND

Advertising provides a channel for individuals and organizations to communicate with the public. For example, online telephone directories and paper-based telephone directory listings, such as the YELLOW PAGES, may provide a source of advertising. An advertisement often presents persuasive information, such as information about goods and/or services, and contact information, such as a website address, e-mail address, telephone number, mailing address, and/or the like. The advertisement itself may have various objective characteristics, such as shape, size, color-use, page and/or screen placement, nature of distribution (i.e., online telephone directory, YELLOW PAGES, WHITE PAGES, companion book, etc.), geographic area, market size, categorization, keywords, and/or the like.

The public's response to the advertisement may be used to rate the advertisement's effectiveness. For example, in a paper-based telephone directory advertisement, the advertisement's effectiveness may be related to the number of telephone calls the advertisement generates. Also for example, in an online telephone directory advertisement, the advertisement's effectiveness may be related to the number of views and/or click-throughs it receives, in addition to the number of telephone calls the advertisement generates.

This data about the public's response may be used to model how various advertisement characteristics relate to the advertisement's effectiveness. For example, the data may be used to determine and quantify a general correlation between advertisement size and call rates. This data may be useful for individuals and/or organizations contemplating purchasing an advertisement. This data may be important to those selling such advertisements, as it may provide objective and measurable support of the advertisement's value proposition to the individual and/or organization. However, this data may be generated from disparate sources and formats, and the meaning behind the data may be difficult to convey to individuals and/or organizations contemplating purchasing an advertisement.

### SUMMARY

An advertisement sales tool, disclosed herein, conveys complex data from disparate sources in an understandable way. It is particularly helpful for individuals and/or organizations contemplating purchasing an advertisement. The disclosed system and methods may enable presenting online and paper-based telephone directory advertisement effectiveness. The system may include a user interface and a processor. The user interface may receive input. The input may be indicative of an advertisement characteristic. The advertisement characteristic may be part of an advertising mix. The advertisement characteristic may be in accordance with a paper-based telephone directory advertisement and/or an online telephone directory advertisement.

The processor may determine one or more effectiveness metrics, such as monthly call counts. The effectiveness metrics may be based on the user input and data indicative of advertising effectiveness. This data may be based on metered telephone directory listing information. The metered telephone directory listing information may be generated by placing a number of unique metered telephone numbers in advertisements, recording data associated with calls made to these unique metered telephone numbers, and statistically processing the recorded data to generate models of how various advertisement types and characteristics influence the call volumes. Online advertisement, with page view and click-through information, may also be used.

The user interface may interactively present a sample advertisement that is in accordance with the inputted characteristic and the effectiveness metric. The interface may generate a customized sales exhibit that includes a sample advertisement that is in accordance with the inputted characteristic and the effectiveness metric.

To illustrate, in a meeting with the prospective client, an advertising sales representative may, via the disclosed tool, input various components and characteristics of a proposed advertising mix. The advertising sales representative may include or exclude different advertisement types, may change the size, type, and style of various advertisements, may consider different markets in which the proposed advertisement may be displayed, or the like. With each change, a corresponding call count may be provided. In addition, a return on investment calculation based on information about the prospective client's business and the call count information may be presented. Thus, the advertising sales representative may provide the client with a proposed, customized advertising mix backed by an objective, evidence-based value proposition and return on investment calculation.

### BRIEF DESCRIPTION OF THE DRAWINGS

FIG. 1. depicts an example system for telephone number metering.

FIG. 2 depicts an example graphical user interface display for presenting telephone directory advertising effectiveness.

FIG. 3 depicts an example exhibit for presenting telephone directory advertising effectiveness.

FIG. 4 depicts an example system for presenting telephone directory advertising effectiveness.

FIG. 5 depicts an example method for presenting telephone directory advertising effectiveness.

### DETAILED DESCRIPTION

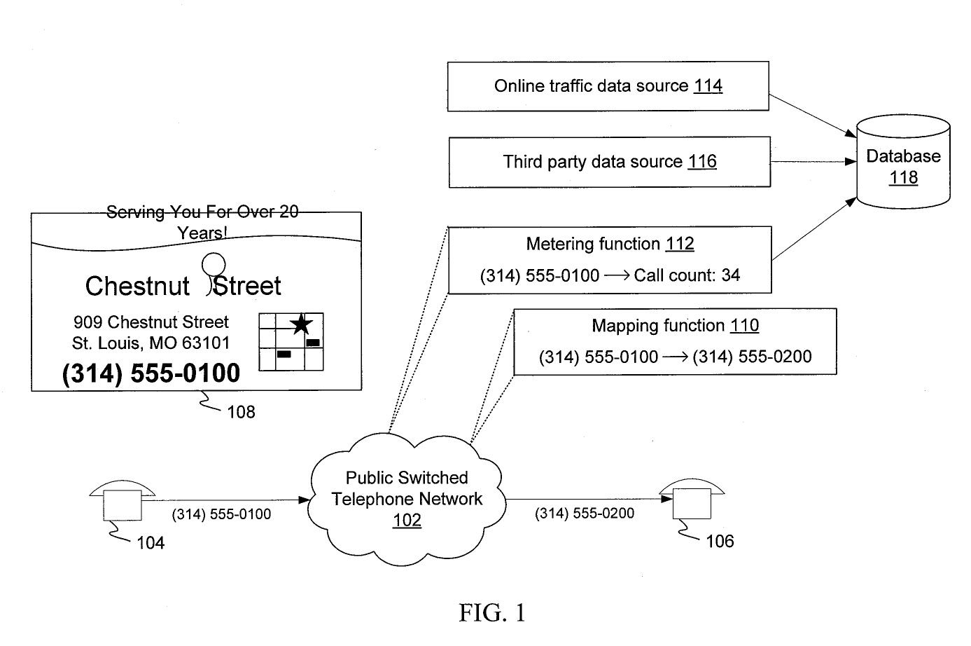

FIG. 1 depicts an example system for telephone number metering. The system may include a PSTN 102 (public switched telephone network) that connects a calling party 104 to a called party 106. The PSTN 102 may interconnected telephone switches (also known as central offices (CO)) that may include, for example, Electronic Switching System (ESS), VoIP soft switches, and the like. These may be manufactured by, for example, Lucent Technologies, Inc. or Nortel.

The telephone switches may include internal call processing logic and/or they may include advanced intelligent network, AIN, functionality to launch queries to and receive commands and data from service control points (SCP). The telephone switches may be connected via trunks that may be controlled via Signaling System Seven (SS7), multi-frequency (MF) signaling, primary rate interface (PRI) signaling, or the like. The PSTN 102 may include equipment suitable for processing Voice over IP calls, such as soft switches, Voice over IP gateways, and the like.

As illustrated, the calling party 104 may view an advertisement 108. The advertisement 108 may be displayed, for example, in a paper-based telephone directory, such as the Yellow Pages, a companion paper-based telephone directory, a white pages telephone directory, an online telephone directory, such as YellowPages.com, or the like. The advertisement 108 may have one or more characteristics that make it attractive to the calling party 104. For example, the advertisement 108 may be associated with a particular category, for example, a category related to a specific good or service. The advertisement 108 may have a defined size and/or placement that makes it stand apart from other advertisements. The advertisement 108 may have a picture, color, or other characteristics.

The advertisement 108 may include a telephone number. The telephone number may be a metered telephone number. The metered telephone number may be unique to the specific instance of the advertisement 108. Since there may be a relationship between the metered telephone number and the advertisement 108, a call count associated with the metered telephone number may be indicative of the effectiveness of the specific advertisement 108.

The calling party 104 may dial the unique metering telephone number. The call may be received by the PSTN 102. Within the PSTN 102, a mapping function 110 and a metering function 112 may be applied. These functions may implemented within any PSTN 102 element and/or combination of such elements, including on-board call logic in a telephone switch, AIN elements (e.g., SCP), billing/recording systems, etc.

The metering function 112 may maintain a call count associated with the unique metered telephone number. The metering function 112 may store the call count information over time. The metering function 112 may include related data with each call count, such as source calling party number, originating telephone switch identifier, date, time, duration, etc. The metering function 112 may store the call count and related data as metering data in a database. The database may aggregate the metering data for a given service provider. The database may receive metering data from multiple service providers and/or third party vendors.

The metering data may include one or more characteristics of each of the corresponding advertisements. For example, the metering data may include the distribution market size, the category heading, and/or advertisement size of the advertisements 108 having metered telephone numbers. Base on the relationship between metered telephone number and call counts, the effectiveness of the various advertising characteristics may be determined. Thus, the metering data may serve as a model for determining the effectiveness of the advertisement 108.

Furthermore, where the advertisement 108 is an online advertisement. In addition to call counts associated with metered telephone numbers listed in the online advertisement, online traffic data, such as page views and click-throughs, may be recorded. The online traffic data may be delivered from an online traffic data source 118. For example, the webserver hosting the online advertisement may maintain log files of the page views (i. e., impressions) and click-throughs. The log files may be parsed and the data aggregated to define online traffic data associated with the advertisement 108. Thus, the metering data may include online traffic data to serve as a model for determining the effectiveness of the advertisement 108. For example, the effectiveness of the online telephone directory advertisements may include click-through rate (CTR). An example CTR may be calculated by dividing the number times an advertisement was clicked by the by the number of times the advertisement was presented. For example, the effectiveness of the online telephone directory advertisements may include an impression count. An example, impression count may be calculated by recording the number of time the advertisement was presented over a period of time. The impression count may be based on the total number of presentations. The impression count may be based on independent presentations (i.e., an adjustment that removes extra presentations of the advertisement to the same person). The online traffic data may be correlated to one or more characteristics of online telephone directory advertisements. For example, CTR may be correlated to the size, placement, color, interactive features (e.g., reviews, comments, social network interoperability, ratings, and the like), video and/or animated features, etc.

Search engine results may be measured to define online traffic data to serve as a model for determining the effectiveness of the advertisement 108. For example, a user searching for information about a particular good or service via an Internet search engine may be presented with an online telephone directory advertisement in the corresponding search engine results. The impression count and the CTR for advertisements associated with search engine results may be calculated to define online traffic data.

Third party data sources 116 may provide data related to call metering and/or online traffic. For example, a data analyst vendor may provide metrics, models, raw data, etc. in connection with the effectiveness of various features and characteristics of telephone directory advertisements. The data may be sourced from other network carriers, industry groups, marketing focus research, etc. This data may correlate aspects of paper-based and online telephone directory advertisements to effectiveness metrics such as call counts and CTR, for example.

Any of the metering function 112, online traffic data source 114, and third party data source 116 may store data in a database 118. The database 118 may use the call metering and/or online traffic data to model the effectiveness of various aspects of paper-based and online telephone directory advertisements, as discussed further below.

The mapping function 110 may translate the unique metered telephone number to the actual number of the called party 106. The PSTN 102 may, in turn, route the call to the correct called party. The PSTN 102 may ring the called party 106, and upon answer, cut through the voice path, so that the calling party 104 and called party 106 may converse.

Since this metered call was based on the calling party viewing the advertisement 108, it may be likely that the calling party 104 is calling the called party 106 with an intent towards goods and/or services referred to in the advertisement 108. The call may constitute a “lead” to the called party 106 for making a sale. Thus, the effectiveness of the various characteristics of the advertisement may have a direct relationship to the revenue and sales volume of the called party 106. However, this aggregate metering data, in itself, it not easily viewed, parsed, organized, or presented in a way that makes it accessible to the called party. The following interfaces, systems, and methods, may make this data accessible and understandable. For example, a representative selling telephone directory advertisements may be able to use the following to present an objective, evidence-based value proposition to a potential advertiser in a way that was not previously possible.

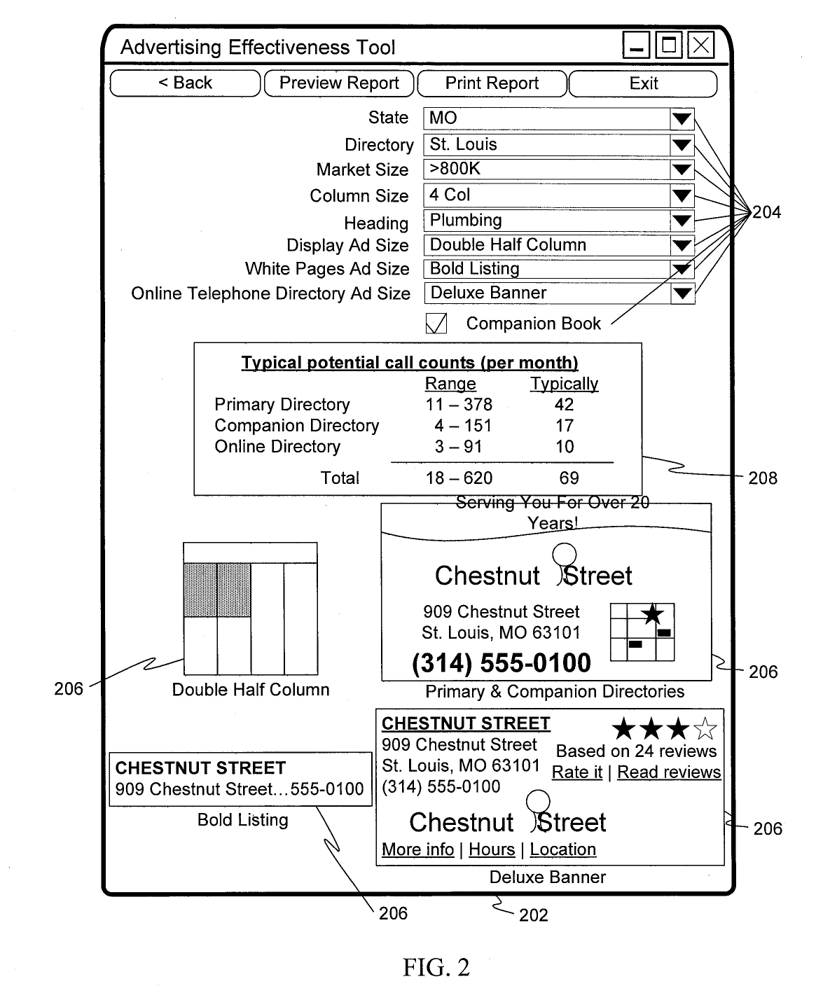

FIG. 2 depicts an example graphical user interface 202 for presenting telephone directory advertising effectiveness. Based on the aggregate metering data from telephone number metering and online traffic information, an advertising effectiveness tool may be used to analyze and present information related to advertising effectiveness. The advertising effectiveness tool may enable a user to quickly parse pertinent aspects of the data and present it in interactive fashion. The interactivity may be suitable for a presentation from an advertising sales representative to a prospective advertising customer. The tool may be implemented as software on a personal computer, a web-based application, and/or any other computing interface suitable for receiving input and presenting data.

The graphical user interface 202 may include one or more user input fields 204. The user input fields 204 include defining structure such as labels, data types, field sizes, selection options, and input criteria suitable for advertising data. For example, the user input field 204 may be adapted to receive characteristics of an advertising mix, such as number and type of advertisements, size of the advertisements, the categorization of the advertisements, or the like. Also for example, the user input fields 204 may receive the city and state of a prospective advertising mix.

Based on the city and state entry, the tool may auto-populate the appropriate market size, column size, and companion book fields. The market size may include the distribution volume of a primary paper-based telephone directory book in that market. The column size may include the format type (i.e., number of columns width per page) of that primary paper-based telephone directory book. The tool may refer to stored advertising effectiveness data to determine the market size and column size based on the entered city and state. The market size and column size input fields may be manually changed by the user.

As illustrated, the city/state combination of St. Louis, Mo. may have a primary paper-based telephone directory in a four column format with a distribution volume that is greater than 80,000 books.

The user may use the user input fields 204 to define an advertising mix. The advertising mix may one or more advertisements and their defining characteristics. For example, the advertising mix may be a telephone directory advertising mix. The advertising mix may include a paper-based primary telephone directory advertisement, a white pages directory advertisement, an online telephone directory advertisement, an advertisement in paper-based companion telephone directory (i. e., a second, typically smaller book, published in the same market), or the or the like.

For the advertisements in the advertising mix, the user may define characteristics as appropriate. For example, the user may choose from a selection of variable sizes. For example, a paper-based primary telephone directory advertisement size may be selected from a list including single column, double column, double half-column, half-page, full-page and the like. The user may select a corresponding category heading for the advertisement. Other characteristics may include the use of color in the advertisement, the use of photographs in the advertisement, page placement, etc. As illustrated in FIG. 2, the user may provide a display advertisement size, a white pages advertisement size, an online telephone directory advertisement size, and/or an indication of whether a corresponding advertisement would be listed in a companion book. The characteristics of the advertisement such as display size are illustrated here for example only other advertisement characteristics may be included.

In response to the user input field 204, the tool may present one or more sample advertisements 206 and one or more metrics 208 indicative of the advertisement's effectiveness. The tool may interactively present a representation various aspects of the advertising mix. For example, the tool may present a representation of how the paper-based advertisement would look on a page. For example, the tool may present a graphical representation indicate indicating the relative size between a defined advertisement and a page from the telephone directory. A sample advertisement 206 may be displayed providing the user a visual indication of shape and the nature of the user-defined advertisement. This sample advertisement 206 may be a sample of the advertisement defined for the paper-based primary and companion telephone directory. The tool may show a corresponding sample advertisement 206 for the white pages and for the online telephone directory.

The tool may also present one or more metrics 208 indicative of the effectiveness of the defined advertising mix. The metrics may represent an expected effectiveness of the advertising mix if published and distributed with the characteristics as defined. A metric may relate the components and characteristics of the advertising mix to historic metered call data and online traffic data to determine the expected effectiveness. For example, an advertising mix with more components, larger size advertisements, in a market with greater distribution volume may be expected to generate more calls than more limited advertising mixes. Also, for example, a larger advertisement in full-color may generate more calls than a smaller advertisement in a single color.

The metric may be call counts, for example. The interface 202 may provide a minimum, maximum, and median call counts per month associated with an advertisement in accordance with that selected by the interface. The tool may provide online traffic data associated with an advertisement in accordance with the online telephone directory advertisement size, for example. The tool may display the metrics interactively based on the user input. Thus, the metrics may vary according to the selected characteristics and components of the selected advertising mix.

As illustrated, a primary directory advertisement with a double half column size in the plumbing category in the St. Louis, Mo. market (i. e., a four-column format directory with a greater than 800,000 distribution volume) may be generate between 11 and 378 calls per month. The call count may be typically 42 calls per month. This may correspond to the recorded historical and statistically calculated call data. Similar metrics are shown for the companion directory advertisement and the online directory advertisements. Although not shown, similar metrics may be provided for the white pages advertisement.

These metrics may provide an overall effectiveness of the advertising mix defined by the user. For example, these metrics may provide an corresponding historical performance of similar advertising. The advertising effectiveness tool may enable an advertising sales representative to provide to a potential advertising customer, a customized advertising mix with call count data that may be used to formulate a value proposition for the potential customer. Since the tool is interactive, in a meeting with the prospective client, the advertising sales representative may alter components and characteristics of the advertising mix, including changing the size of various ads, including or excluding advertisement types, and considering other markets. With each change, corresponding call count data may be provided. Thus, the advertising sales representative may provide, in an interactive setting with the client, a customized advertising mix with an objective, evidence-based value proposition. For example, the tool may include a return on investment calculation.

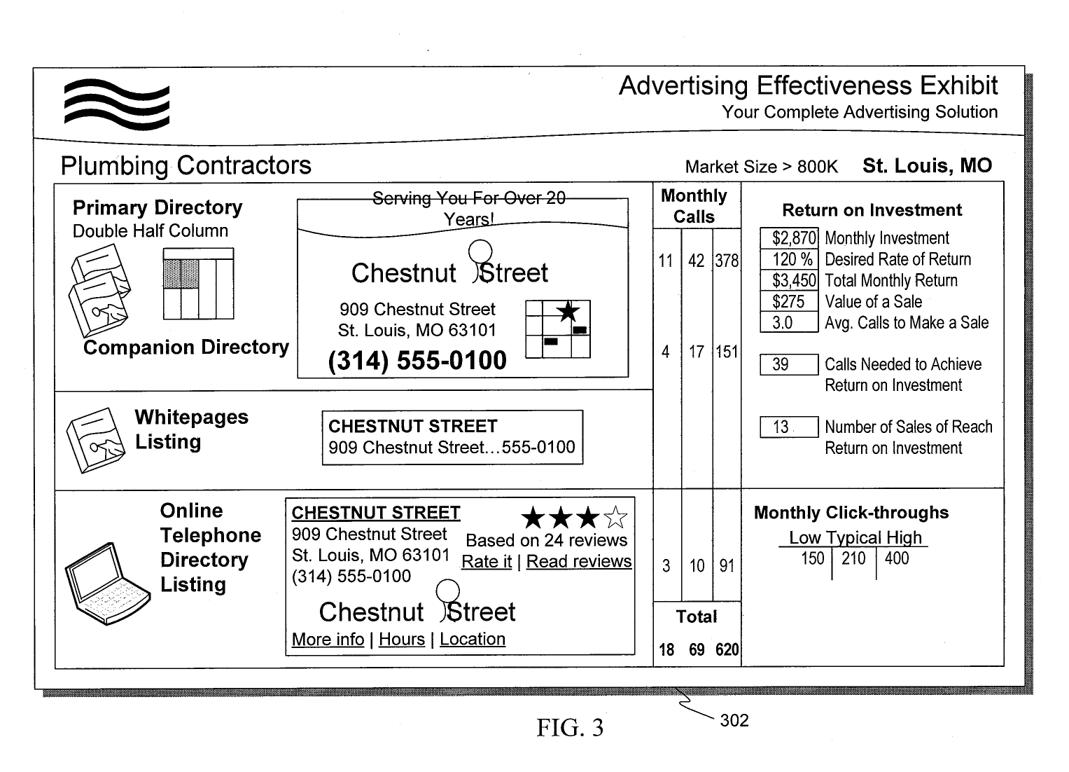

The tool may include one or more navigation buttons to exit the system, to return to a home menu screen, or the like. The tool may include a preview report button and a print report button that generates an exhibit (see FIG. 3) corresponding to the defined advertising mix and corresponding effectiveness metrics.

FIG. 3 depicts an example exhibit 302 for presenting telephone directory advertising effectiveness. The exhibit 302 may be presented on a computer screen. The exhibit 302 may be saved as a digital file, such as an image file or PDF (portable document file), for example. The exhibit 302 may be printed to a hardcopy.

The exhibit 302 may contain information corresponding to that presented by the advertising effectiveness tool. For example, the exhibit 302 may include the city and state selection, the corresponding market size, and the selection of the advertising mix made via the advertising tool. For example, the exhibit 302 may include the associated monthly minimum, maximum, and median call counts.

The exhibit 302 may include a return on investment calculation. For example, the return on investment calculation may include a monthly investment figure associated with the cost of the advertising mix. The return on investment calculation may include a desired rate of return and corresponding total monthly return, the average value of a sale associated with the prospective advertiser, and the average number of calls to make a sale associated with the prospective advertiser. The return on investment calculation may determine the number of calls needed to achieve the return on investment and the number of sales needed to reach the return on investment. These figures may be compared to the monthly call counts provided by the advertising mix. Thus, the tool and/or exhibit 302 may be used to provide a customized, evidence-based value proposition to the potential advertiser.

In addition, the exhibit 302 may include online traffic data associated with an online telephone directory advertisement. The online traffic data may include page views and click-throughs associated with the online telephone directory listing as defined.

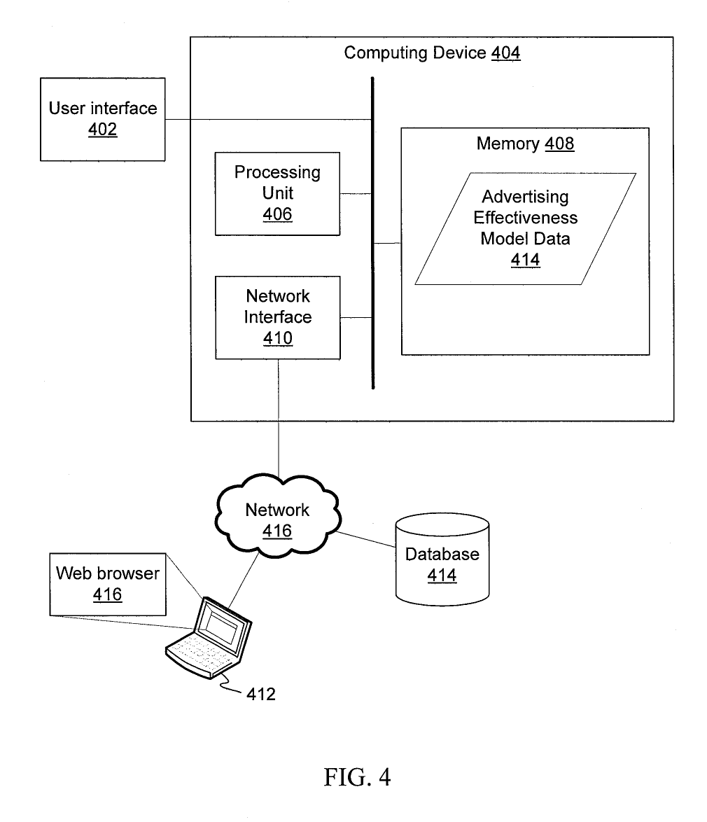

The tool and corresponding exhibit 302 may be implemented via a computing system and/or method. FIG. 4 depicts an example system for presenting telephone directory advertising effectiveness. The system may be a suitable computing environment in which the tool may be implemented. Although not required, the tool may be implemented via computer executable instructions, such as program modules, being executed by the computer device, such as a client workstation, server, laptop, handheld, smart phone, etc. Computer executable instructions may include routines, programs, objects, components, data structures and the like that perform particular tasks or implement particular abstract data types. The computer executable instructions may be stored on computer readable storage medium, such as hard drives, flash drives, CD-ROM media, and the like.

The system may include a user interface 402 in communication with a computing device 404. The computing device 404 may include a processing unit 406, a memory 408, and a network interface 410. The computing device 404 may be in communication with a remote computer 412 and a database server 414 via a network 416. The tool may also be practiced in distributed computing environments where tasks are performed by remote processing devices that are linked through a communications network 416.

The computing device 404 may operate in a networked environment using logical connections via a network interface 410 to a network 416. The network interface 410 may provide connectivity to a data network 416 that enables connectivity to a database server 414 and a remote computer 412 with a web browser 416. The remote computer 412 may be a personal computer, a server, a router, a network PC, a peer device or other common network node. The network 416 may include a local area network (LAN), a wide area network (WAN), intranets, the Internet, and the like. The network interface 410 may include a telephony modem, Ethernet interface, token-ring interface, Gigabit Ethernet interface, fiber channel interface, wireless network interface 410, or the like.

The memory 408 may include read only memory 408, random access memory, hard disk drive, a magnetic disk drive, an optical disk drive, flash drive memory, or the like. The drives and their associated computer readable storage media may provide non-volatile storage of computer readable instructions, data structures, program modules and other data.

The database server 414 may include a database. The database may be any component, system, or subsystem suitable for storing and managing structured data. In an embodiment, the database may be part of computing device 404. The database may receive telephone metering data and/or online traffic data. The database may receive telephone metering data and/or online traffic data from a service provider. The database may receive telephone metering data and/or online traffic data from a third party vendor that aggregates data from multiple service providers.

The computing device 404 may receive the advertising effectiveness model data 414 from the database server 414 via the network interface 410 and the network 416. For example, the database server 414 may contain a first version of the advertising effectiveness model data 414 and the computing device 404 may contain a second version of the advertising effectiveness model data 414. A synchronization process may be used, at regular intervals or on demand for example, to ensure that a new version of advertising effectiveness model data 414 and/or corresponding software from the database server 414 may be downloaded to the memory 408 for use by the computing device 404.

The telephone metering data and online traffic data may be processed by the processing unit 406 into advertising effectiveness data. The advertising effectiveness data may be stored in memory 408. The advertising effectiveness data may be structured as one or more database tables. The advertising effectiveness data may define the relative effectiveness of various advertisement characteristics. For example, The advertising effectiveness model data 414 may be a collection of data that relates advertising characteristics to call counts. For example, raw metering and online traffic data may be correlated with advertising characteristics to define the effectiveness of the various advertisement characteristics. The advertising effectiveness model data 414 may include explicit call count information, historical call count information, and/or expected call counts. Raw metering and online traffic data may be processed to generate advertising effectiveness data. The processing may include multivariate statistical processes, such as multivariate analysis of variance, discriminant function analysis, canonical variate analysis, regression analysis, principal components analysis, linear discriminant analysis, logistic regression analysis, artificial neural network methods, multidimensional scaling, canonical correlation analysis, recursive partitioning, or the like. The advertising effectiveness model data 414 may be segmented according to characteristics of the advertisement such as market size, advertisement size, listing category, and the like. The advertising effectiveness model data 414 may be provided originating at a service provider, third-party vendor, a combination of service provider and third party vendor, or the like.

The user interface 402 may enable input and output with the computing device 404. A user may enter commands and information into the computing device 404 via the user interface 402. The user interface 402 may include a graphical user interface. For example, the user interface 402 may include input devices such as a keyboard and mouse and output devices such as a video adapter, monitor, and printer.

The user interface 402 may be used to receive input indicative of an advertising mix. The advertising mix may include paper-based telephone directory advertisements and/or online telephone directory advertisements. The user interface 402 may interactively present a representation of the advertising mix. For example, the user interface 402 may include plurality of selection boxes to receive input. The user interface 402 may present to the user a graphical representation of the selections made. The user interface 402 may interactively present to the user a plurality of metrics indicative of the effectiveness of the advertising mix. For example, the user interface 402 may present a call count per month metric, a table of call counts, a collection of graphs or charts, or the like.

Similarly, the user interface 402 may present the advertising mix and/or effectiveness metric as an exhibit 302. The exhibit 302 may include a digital file, such as a wordprocessing document, an image file, a portable document format file, or the like. The exhibit 302 may be printed. The exhibit 302 may be e-mailed.

The user interface 402 may enable use of the tool at the remote computer 412. For example, the computing device 404 may provide a graphical user interface to a web browser 416 of a remote computer 412 via the network 416 and network interface 410. For example, the graphical user interface may be formatted as a markup language file that is transmitted between the computing device 404 and the remote computer 412. The computing device 404 may be a webserver providing the advertising effectiveness tool is a web application to the web browser 416 on the remote computer 412.

The computing device's processing unit 406 may be a microprocessor, microcontroller, or the like. Moreover, those skilled in the art will appreciate that tool may be practiced with other computer system configurations, including multi processor systems, microprocessor based or programmable consumer electronics, network PCs, minicomputers, mainframe computers and the like.

The processing unit 406 may receive the input from the user interface 402 and may generate an output to the user interface 402. The processing unit 406 may generate the sample advertisement associated with the input from the user. The processing unit 406 may operate on the input in connection with advertising effectiveness model data 414 from the memory 408 and determine the plurality of metrics to be presented by the user interface 402. For example, the processor may generate a query based on input from the user.

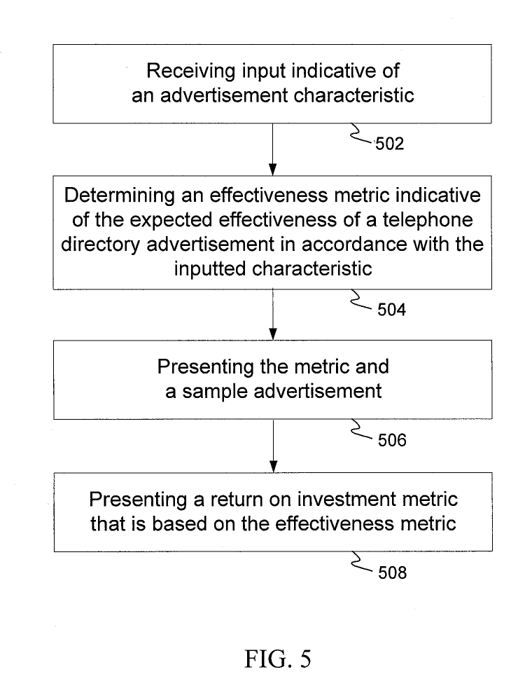

FIG. 5 depicts an example method for presenting telephone directory advertising effectiveness. The example method may be a computer implemented method. For example, the instructions and processes described in FIG. 5 may be performed by a computing device, such as that depicted in FIG. 4, for example. The instructions depicted in this example method may be implemented as computer executable instructions and may be stored on a computer readable storage medium, such as a hard drive, flash drive, internet download, CD-ROM, or the like.

At 502, input of an advertisement characteristic may be received. For example, a user may enter an advertisement characteristic into a user interface. The user may enter a category heading, an advertisement display size, a market size, whether or not color is used in the advertisement, the various distribution channels for the advertisement, or the like. The distribution channels may include a primary telephone paper-based telephone directory, a secondary or companion paper-based telephone directory, white pages telephone directory listing, an online telephone directory listing, or the like.

At 504, an effectiveness metric may be determined. The effectiveness metric may be indicative of the expected effectiveness of an actual, published advertisement in accordance with the inputted characteristic. A published advertisement in accordance with the inputted characteristic may be a published advertisement that embodies the characteristic, such as advertisement size and/or color use, for example. A published advertisement in accordance the inputted characteristic may be a advertisement published in accordance with the characteristic, such in a market or distribution method defined by the characteristic, for example.

The effectiveness metric may be indicative of the advertisement's expected effectiveness. For example, the effectiveness metrics may be a call count, such as monthly call counts. The effectiveness metric may include a minimum, median, and/or maximum call volume. The effectiveness metric may be page view and/or click-through information.

Determining the effectiveness metric may be based on the received input and on data that models advertising effectiveness. Data that models advertising effectiveness may include data that models advertising effectiveness of telephone directory information including metered telephone directory listing information and/or online traffic telephone directory listing information.

The modeling data may include aggregate metering data from telephone service operations of a service provider. This metering data may be relationally mapped to various characteristics of an advertisement, such as category, market size, advertisement size, etc., such that an call volume may be determined.

At 506, the metric and a sample advertisement may be presented. The metric and sample advertisement may be presented via a user interface, such as a local graphical user interface, an exhibit, and/or a remote web-based user interface. For example, the metric and sample advertisement may be presented in a software window view. The presenting may include generating a customized sales exhibit 302 that includes both the metric in the sample advertisement. The exhibit 302 may include a printed a hard copy and/or a digital file, such as an image file or portable document file. The presenting may include sending the metric and sample advertisement as a markup language file adapted to be displayed by a receiving web browser 416. In this sense, the metric and sample advertisement may be presented in a local and/or remote fashion.

The sample advertisement may be in accordance with the inputted characteristic. The sample advertisement may be in accordance with the inputted characteristic by including any indication of the characteristic. This may enable a viewing user to better understand how an actual published advertisement with that characteristic could be represented. The advertisement may be in accordance with the inputted characteristic by embodying the characteristic. For example, if the inputted characteristic is color use, the sample advertisement may be presented with corresponding color use. For example, if the inputted characteristic indicates a type of advertising format, the sample advertisement may be displayed having that type of format. The advertisement may be in accordance with the inputted characteristic by representing the inputted characteristic. For example, where the inputted characteristic is market size, the sample advertisement may be displayed with an indication of market size, such a text label adjacent the sample advertisement. For example, where the inputted characteristic is advertisement size, the advertisement may be shown with a size relative and/or in proportion with the inputted size. Also for example, where the inputted characteristic is advertisement size, the advertisement shown may be shown in connection with a graphical representation of the advertisement on a page, showing the relative size of the advertisement to a page, such as a webpage or paper page of a paper-based online telephone directory.

At 508, a return on investment calculation may be presented. The return on investment calculation may be based on the effectiveness metric and other user inputted data. A user may enter the cost of the advertisement and assumptions about the relationship between received calls and revenue. Then, based on the effectiveness metric, it may be determined if the presently defined advertisement, or advertising mix, provides an effective generation of monthly calls to justify the expense of the advertisements.

In an embodiment, this method may be used to a receiving advertising mix, at 502. The advertising mix may include various characteristics of more than one advertisement. Similarly, one or more effectiveness metrics may be determined, at 504. The determination may be based on including and excluding various components of the advertising mix based on the characteristics of the various advertisements included in the mix. A representation of the advertising mix and the effectiveness metric the may be presented, at 506.

In an embodiment, the presenting, at 506 and 508, and determining, at 504, may be interactively responsive to receiving input, at 502. For example, in a computer implemented embodiment, a graphical interface may be used to receive input from the user and interactively respond to the received input to determine the effectiveness metric and to present the metric and a sample advertisement to the user. Then, the user may change the input values, and the determining and presenting steps may interactively respond, appropriately changing the presented metric and sample advertisements accordingly. In this sense, the tools and methods presented herein may be used in an interactive setting between an advertising sales representative and a prospective advertiser. The two may work together adjusting and redefining the input and considering the output, until an appropriate evidence-based, value proposition is established.

What is claimed:

1. A system for presenting advertisement effectiveness, the system comprising:
a user interface configured to receive input indicative of a plurality of telephone directory advertisements, wherein the user interface interactively presents a representation of the plurality of telephone directory advertisements and a plurality of metrics indicative of the effectiveness of plurality of telephone directory advertisements; and
a processor configured to determine the plurality of metrics based on at least metered telephone directory listing information.

2. The system in accordance with claim 1, wherein the plurality of telephone directory advertisements comprises at least one of a paper-based telephone directory advertisement or an online-telephone directory advertisement.

3. The system of claim 2, wherein the processor determines the plurality of metrics based on at least metered telephone directory listing information and click-through online telephone directory listing information.

4. A computer-implemented method comprising:
receiving input indicative of an advertisement characteristic;
determining an effectiveness metric indicative of an expected effectiveness of a telephone directory advertisement in accordance with said characteristic; and
presenting the metric and a sample advertisement, wherein the sample advertisement is in accordance with said characteristic.

5. The method of claim 4, wherein the telephone directory advertisement is a paper-based telephone directory advertisement.

6. The method of claim 4, wherein the telephone directory advertisement is online telephone directory advertisement.

7. The method of claim 4, wherein said effectiveness metric is indicative of call volume.

8. The method of claim 4, wherein the advertisement characteristic is any of size, shape, market size, distribution method, or color use.

9. The method of claim 4, wherein said determining comprises determining the effectiveness metric based on the input and on data that models advertising effectiveness.

10. The method of claim 9, wherein the data that models advertising effectiveness is data that models advertising effectiveness of telephone directory information.

11. The method of claim 9, wherein the data that models advertising effectiveness includes metered telephone directory listing information.

12. The method of claim 9, wherein the data that models advertising effectiveness includes online telephone directory listing traffic information.

13. The method of claim 4, wherein said presenting and determining are interactively responsive to said receiving.

14. The method of claim 4, wherein said presenting comprises sending the metric and the sample advertisement in a markup language file adapted to be displayed by a receiving web browser.

15. The method of claim 4, wherein said presenting comprises generating a customized sales exhibit that includes the metric and the sample advertisement.

16. A computer-readable storage medium having computer instructions stored thereon that when executed in a computing environment perform a method comprising:
receiving input indicative of an advertisement characteristic;
determining a metric indicative of an expected effectiveness of a real advertisement in accordance with said characteristic; and
presenting the metric and a sample advertisement, wherein the sample advertisement is in accordance with said characteristic.

17. The computer-readable storage medium of claim 16, wherein the advertisement is a paper-based telephone directory advertisement.

18. The computer-readable storage medium of claim 16, wherein the advertisement characteristic is any of size, shape, market size, distribution method, or color use.

19. The computer-readable storage medium of claim 16, wherein said determining comprises determining the effectiveness metric, based on the input and on data that models advertising effectiveness.

20. The computer-readable storage medium of claim 19, wherein the data that models advertising effectiveness is data that models advertising effectiveness of telephone directory information.
